(19) United States
(12) Patent Application Publication
(10) Pub. No.: US 2008/0143951 A1
(43) Pub. Date: Jun. 19, 2008

(54) Universal, cuttable clip-on auxiliary lens system and method of assembly

(76) Inventor: Haion Won, Basking Ridge, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/638,054

(22) Filed: Dec. 13, 2006

(51) Int. Cl. G02C 7/08; G02C 9/04

(52) U.S. Cl. 351/57; 351/178

(57) ABSTRACT

A universal, cuttable clip-on auxiliary lens system and method of assembly provides cut-able auxiliary lenses which are universally sized through custom tailoring to fit virtually any prescription eyeglasses lenses. The universal, cuttable clip-on auxiliary lens system includes a material sheet having a first lens portion, a lens mounting member and a second lens portion. The first and second lens portions are adapted to be traced upon to form a traced outline of a pair of prescription eyeglass lenses. Sizing of the first and second lens portions is achieved by cutting along the traced outline so that the lenses are tailored to optimally cover the lenses of the eyeglasses. The tailored auxiliary eyewear is removably mounted on the prescription eyeglasses by way of the lens member mounting device. The auxiliary eyewear offers effortless mounting and custom tailoring while providing a lightweight construction that can be worn with comfort over extended periods of time.

### BACKGROUND OF THE INVENTION

1. Field of the Invention

The present invention relates to clip-on auxiliary eyewear; and more particularly, to a universal, cuttable clip-on auxiliary lens system and method of assembly having cut-able auxiliary lenses that are lightweight and can be universally sized through custom tailoring to be securely mounted on a wide variety of prescription eyeglasses.

2. Description of the Prior Art

Auxiliary lens members appointed to be removably mounted upon prescription eyeglasses are commonly utilized to shield eyes from harmful ultraviolet rays and/or airborne particles. Existing auxiliary eyewear attachment apparatuses utilize clip-on mechanisms that are relatively complex, heavy to wear and tend to convey a stern, overbearing appearance. Their complex holding mechanisms increase eyeglass weight, causing the eyeglasses to slip downwardly along the bridge of the nose, or cause discomfort to the wearer. Downward slipping is especially prevalent when the wearer's nose becomes moistened during energetic activity, such as participation in competitive sports.

Typically, these existing clip-on auxiliary sunglasses include a pair of lenses each provided with clips on the rims thereof and are attached together by way of a bridge member arranged to be removably mounted on prescription glasses. For example, U.S. Pat. No. 6,557,997 to Sieberg discloses clip-on sunglass lenses wherein the lens pair is joined by way of a bridge wire and is appointed with clips so that the lens pair can be removably engaged over front surfaces of eyeglasses. U.S. Pat. No. 7,048,374 to Ng discloses clip-on auxiliary lenses utilizing an elastic jaw in the shape of a half arc and lens rim clips for removable attachment over the front lenses of eyeglasses. U.S. Pat. No. 6,685,314 to Friedman discloses clip-on sunglasses having lens sections joined by a spring mechanism which pulls the lens sections toward each other so that prongs mounted on the rims of each lens section engage with an eyeglasses frame. U.S. Pat. No. 6,280,029 to Salk teaches eyeglass clip-on eyewear appointed with clasp components and a bridge member appointed to engage with an eyeglass's frame. U.S. Pat. No. 5,321,443 to Huber et al. discloses a removable sunglass assembly providing a clamping force for attachment to a conventional pair of eyeglasses. U.S. Pat. No. 4,247,178 to Cook discloses clip-on sunglasses for wire frame spectacles wherein the sunglasses include a pair of spaced posts having a slot opening extending rearward therefrom appointed for receiving the wire frame of the spectacles.

These aforementioned existing clip-on sunglasses do not provide the ability to optimally fit the sunglass lenses to the eyeglasses, as the sunglass lenses cannot be tailored to the specific dimensions and shape of the eyeglasses. Instead, these assemblies are typically presented in standard sizes, which may or may not provide adequate lens coverage for a wearer's specific eyeglasses. Bulky, complex clip-on mechanisms utilized by these clip-on auxiliary sunglasses not only hinder mounting onto the eyeglass frame, but increase the weight of the assembly on the wearer's nose bridge. Due to the weight of the assembly of the eyeglasses along with the mounted auxiliary clip-on sunglasses, increased pressure and discomfort is typically experienced by wearer's after a period of time. Moisture or perspiration on the wearer's face further impede on comfort, as the heavy assembly tends to slide downwardly along the bridge of the nose.

Still other clip-on sunglass structures commonly utilized involve ever more complex mounting mechanisms, wherein the clip-on glasses are generally not appointed for full removal, but instead provide a “flip-up” function when the sunglasses are not longer needed. For example, U.S. Pat. No. 6,755,521 to Begg discloses a clip-on glasses assembly for mounting on primary glasses comprising a pair of lens members having at least one grapple for engaging the outer edges of the primary glasses and a bridge between to allow movement of the lens members between open and closed positions. Like the removable clip-on sunglass counterparts, these non-removable (generally) clip-on sunglasses do not provide the ability to optimally fit the sunglass lenses to the eyeglasses, as the sunglass lenses cannot be tailored to the specific dimensions and shape of the eyeglasses. Instead, these assemblies are typically presented in standard sizes, which may or may not provide adequate lens coverage for a wearer's specific eyeglasses. Furthermore, these clip-on sunglasses assemblies prove even more complex in mounting the sunglass member to the eyeglass frame. These types of assemblies result in virtually permanent attachment to the eyeglass frame, for “removal” is achieved by “flip-up” function of the sunglass member. Unfortunately, the aesthetics of the eyeglasses, particularly in a professional or social setting, are significantly hindered. The “flipped-up” sunglass member can be quite obtrusive and unattractive. Bulkiness and heaviness represent additional disadvantages associated with these types of auxiliary sunglass devices.

Other auxiliary eyewear attachment apparatuses involve a prescription eyeglass and auxiliary eyewear assembly wherein the prescription eyeglasses include attachment means integrated within the frame thereof for mating with corresponding attachment means integrated within the auxiliary lens members. For example, U.S. Pat. No. 6,234,627 to Agnoli discloses eyeglass devices with removable unitary supplemental lenses. The eyeglass frame is provided with a pair of inwardly facing tabbed projections, each having a channel for inserting an edge of the unitary supplemental lens for removable attachment thereto. U.S. Pat. No. 5,007,727 to Kahaney et al. teaches a combination prescription eyeglass and one-piece sunglass assembly wherein the prescription eyeglass has an elongated flexible plastic support member that engages with a top edge of the one-piece sunglass portion. U.S. Pat. No. 6,979,081 to Zelman teaches an auxiliary eyewear attachment apparatus and method utilizing magnets attached to appendages on the auxiliary eyeglasses mating with magnets mounted on the temple extensions of conventional eyeglasses. U.S. Pat. No. 6,913,355 to Xie discloses a spectacle set including a primary spectacle frame having two nose supports, a detachable shelter frame having lenses attached to a bridge for mounting in front of the primary spectacle frame by way of magnetic attachment located near the bridge.

Eyeglass-auxiliary sunglass assemblies such as these cannot be utilized on a different array of eyeglasses, but can only be utilized with eyeglasses specifically appointed with the attachment means interstitially within the frame. Universal application of the sunglass portion is nullified and the wearer must purchase the specialized eyeglasses in conjunction with the auxiliary sunglasses. Moreover, like the clip-on sunglass counterparts, these assemblies involve complex mounting mechanisms, which are heavy and increase pressure on the wearer's nose bridge. Such increased pressure on the nose bridge can produce indentation grooves causing pain and discomfort. Physical and aesthetic disadvantages associated with the bulkiness of such eyeglass-auxiliary sunglass assemblies are readily apparent.

Various lighter, less complex holding mechanisms are utilized for auxiliary sunglass eyewear, such as electromagnetic forces. However, these auxiliary sunglasses still fail to provide the ability to custom tailor the auxiliary lenses to optimally cover the prescription eyeglass's lenses and further fail to provide adequate securing to the eyeglasses to prevent unwanted dismounting. For example, U.S. Pat. No. 6,557,995 to Edwards (hereinafter, the “'995 patent”) teaches a set of two temporary, disposable glare shields made of thin flexible tinted plastic film appointed to be removably attached to left and right sides of the eyeglasses. The glare shields taught by the '995 patent self-adhere to a person's face and/or an eyeglass's outer surfaces, extending beyond frame perimeters and around both temporal sides thereby completely shielding all adjacent areas surrounding eyes from sunlight and airborne hazards. Mounting on the eyeglass's lenses surface is achieved through electrostatic forces, which can be compromised if any type of particle or debris buildup has accumulated on the eyeglass's lenses or on the surface of the glare shields. Over time, accumulation of particles or grease is inevitable, rendering ineffectual weak mounting onto the lenses, rendering disengagement and detachment of the glare shields. Moreover, the bulkiness of the shields and the overhanging of the shields extending from the lenses of the eyeglasses results in a cumbersome non-aesthetically pleasing appearance for the wearer.

Even when auxiliary sunglasses do provide the ability to custom tailor the auxiliary lenses with those of the eyeglasses so that same can be universally employed, these auxiliary lenses fail to provide adequate securing to the eyeglasses to prevent unwanted dismounting. Typically, these universal auxiliary sunglasses involve lens coverings wherein the lenses removably adhere to the eyeglass lenses by way of electrostatic forces. No mechanical mounting device is provided.

For example, U.S. Pat. No. 6,113,233 to Miller discloses a lens cover system including a sheet of material suitable for use in covering a first lens, a pin suitable for use in making a plurality of holes in the sheet of material around the perimeter of the first lens, a pair of scissors for cutting the sheet of material along the plurality of holes thereby creating a first lens cover, and a storage apparatus; each lens cover adheres to the lenses of eyeglasses through electrostatic cling. U.S. Pat. No. 5,764,333 to Somsel discloses a method and kit for making sunshields for eyeglasses wherein the sunshields are flexible, transparent sheets of smooth plastic film that are retained on lenses of eyeglasses by electrostatic attraction; the eyeglass's lenses are traced and the plastic film is cut to size to fit each of the eyeglass's lenses. Mounting of the auxiliary lenses on the eyeglass's lenses surface is achieved through electrostatic forces alone. This becomes compromised if any type of particle or debris buildup has accumulated on the eyeglass's lenses or on the surface of the glare shields. Over time, accumulation of particles or grease is inevitable. The mounting becomes weak or ineffectual, causing disengagement and detachment of the auxiliary lenses.

Notwithstanding the efforts of prior art workers to construct auxiliary sunglass eyewear for engagement with prescription eyeglasses there remains a need in the art for a universal, cuttable clip-on auxiliary lens system and method of assembly that provides auxiliary lenses which are universally sized by custom tailoring to fit virtually any prescription eyeglasses lenses. In addition, there is a need in the art for a universal, cuttable clip-on auxiliary lens system having a simple, clean and modern design rendering an attractive, discrete, aesthetically pleasing low profile. Also needed in the art is a universal, cuttable clip-on auxiliary lens system that is lightweight, non-cumbersome, and adapted to be removably mounted on a pair of prescription eyeglasses. Further needed is a mounting device of the type described that is uncomplicated in design, inexpensive to construct, and readily and effectively provides a reliable and continuous auxiliary lens to prescription eyeglass mount.

### SUMMARY OF THE INVENTION

The present invention relates to a universal, cuttable clip-on auxiliary lens system and method of assembly that provides cut-able auxiliary lenses which are universally sized through custom tailoring to fit virtually any prescription eyeglasses lenses. Advantageously, the universal, cuttable clip-on auxiliary lens system and method of assembly provides a simple, clean and modern design that is attractive, discrete, and presents an aesthetically pleasing, low-profile appearance. Optimal securing of the universal, cuttable clip-on auxiliary lens system onto the prescription eyeglasses is readily achieved by a simple, yet reliable, lens member mounting device that can be removably attached to the prescription eyeglasses. Owing to the unique mounting mechanism and custom tailoring feature, the universal, cuttable clip-on auxiliary lens system is exceedingly lightweight, and especially suited to be worn with comfort over extended periods of time, even during rigorous physical activity.

The universal, cuttable clip-on auxiliary eyewear comprises a material sheet adapted to be sized and cut for removable attachment to eyeglasses. The eyeglasses are generally typical eyeglasses having a first eyeglass lens with a first lens perimeter, second eyeglass lens with a second lens perimeter, an eyeglass bridge, and left and right appendages. The material sheet has a first lens portion, a lens mounting member and a second lens portion. The first and second lens portions are adapted to be marked to form a traced outline of the first and second eyeglass lenses. In addition, they are adapted to be cut by a cutting device, so that the first and second lens portions are sized to cover the first and second eyeglass lenses. The lens mounting member of the material sheet is adapted to connect the first and second lens portions of the material sheet, and to removably mount the first and second lens portions of the material sheet to the eyeglass bridge of the eyeglasses.

The universal, cuttable clip-on auxiliary eyewear system of the present invention comprises a material sheet adapted to be sized and cut for removable attachment to a pair of eyeglasses, wherein the eyeglasses have a first eyeglass lens with a first lens perimeter, a second eyeglass lens with a second lens perimeter, an eyeglass bridge, and left and right appendages, as is typical of eyeglasses. The material sheet has a first lens portion, a lens mounting member and a second lens portion. The lens mounting member of the material sheet is appointed for connecting the first and second lens portions of the material sheet and for removably mounting the first and second lens portions of the material sheet to the eyeglass bridge of the eyeglasses. A tracing instrument is provided for forming a traced outline of the perimeters of the first and second eyeglass lenses on the first and second lens portions of the material sheet. A cutting means for cutting the sheet of material along the traced outline to form a first and second covering for the first and second eyeglass lenses is provided.

Additionally, the invention herein provides a method of making universal, cuttable clip-on auxiliary eyewear, comprising the first step of placing a pair of eyeglasses having a first eyeglass lens with a first lens perimeter, second eyeglass lens with a second lens perimeter, an eyeglass bridge, and left and right appendages on a material sheet adapted to be sized and cut. The material sheet has a first lens portion, a lens mounting member and a second lens portion. The next step involves aligning the first and second eyeglass lenses with the first and second lens portions of the material sheet and tracing the perimeter of the first and second eyeglass lenses with a tracing instrument to form a traced outline of the first and second eyeglass lenses on the first and second lens portions of the material sheet. Accordingly, the sheet of material is then cut along the traced outline by way of cutting means to form the universal, cuttable clip-on auxiliary eyewear for the eyeglasses. Lastly, mounting of the universal, cuttable clip-on auxiliary eyewear to the eyeglass bridge is achieved by way of the lens mounting member of the material sheet so that the universal, cuttable clip-on auxiliary eyewear is removably mounted on the eyeglasses.

### BRIEF DESCRIPTION OF THE DRAWING

The invention will be more fully understood and further advantages will become apparent when reference is had to the following detailed description of the preferred embodiments of the invention and the accompanying drawings, in which:

FIGS. 1a-1d illustrate an embodiment of the universal, cuttable clip-on auxiliary eyewear adapted to be cut to fit prescription eyeglasses: FIG. 1a shows a front view of the universal, cuttable clip-on auxiliary eyewear wherein the lens mounting member is disengaged; FIG. 1b shows a front view of the embodiment wherein the lens mounting member is engaged in the clip position; FIG. 1c shows a side view of the lens mounting member as comprising a folding member having bendable portions that are manipulated to form a clip-on device; FIG. 1d shows a top view of the auxiliary eyewear removably mounted on prescription eyeglasses;

FIGS. 2a-2b illustrate the universal, cuttable clip-on auxiliary eyewear system and method utilized in preparing and assembling the auxiliary eyewear to fit prescription eyeglasses: FIG. 2a shows tracing of the perimeter of the eyeglass lenses on the material sheet; FIG. 2b shows cutting of the traced outline of the perimeter of the eyeglass lenses so that the first and second lens portions of the material sheet optimally cover the eyeglass lenses;

FIGS. 3a-3b illustrate another embodiment of the universal, cuttable clip-on auxiliary eyewear adapted to be cut to fit prescription eyeglasses: FIG. 3a illustrates a front view of the universal, cuttable clip-on auxiliary eyewear wherein the lens mounting member is disengaged; FIG. 3b illustrates a front view of the lens mounting member engaged in the clip position;

FIGS. 4a-4e illustrate another embodiment of the universal, cuttable clip-on auxiliary eyewear adapted to be cut to fit prescription eyeglasses wherein the first and second lens portions are provided with grooves and the lens mounting member is provided with tongues which are received within the grooves: FIG. 4a shows a front view of the universal, cuttable clip-on auxiliary eyewear wherein the lens mounting member is disengaged; FIG. 4b shows a side view of the lens mounting member utilized in this embodiment of the universal, cuttable clip-on auxiliary eyewear; FIG. 4c shows a side planer view of the lens mounting member of FIG. 4b; FIG. 4d shows a top view of the lens mounting member; FIG. 4e shows a top view of the universal, cuttable clip-on auxiliary eyewear wherein the eyewear is appointed for removable mounting on prescription eyeglasses; and

FIGS. 5a-5c illustrate another embodiment of the universal, cuttable clip-on auxiliary eyewear adapted to be cut to fit prescription eyeglasses wherein the first and second lens portions are provided with apertures and the lens mounting member is provided with buttons which are received within the grooves: FIG. 5a shows a front view of the universal, cuttable clip-on auxiliary eyewear wherein the lens mounting member is disengaged; FIG. 5b shows a side view of the lens mounting member utilized in this embodiment of the universal, cuttable clip-on auxiliary eyewear; FIG. 5c shows a side planer view of the lens mounting member of FIG. 5b.

### DETAILED DESCRIPTION OF THE INVENTION

The present invention relates to a universal, cuttable clip-on auxiliary eyewear, lens system and method of assembly that provides cut-able auxiliary lenses universally sized to fit a wearer's prescription eyeglasses. Custom tailoring is achieved by tracing an outline of the prescription eyeglass lenses on the auxiliary eyewear and cutting the auxiliary eyewear to achieve an optimal fit between the auxiliary eyewear and the prescription eyeglasses. Optimal securing of the universal, cuttable clip-on auxiliary lens system onto the prescription eyeglasses is achieved by way of a lens mounting member that readily removably attaches the auxiliary eyewear to the prescription eyeglasses. Utilization of an effortless mounting mechanism and custom tailoring of the lenses of the universal, cuttable clip-on auxiliary lens system provides lightweight auxiliary sunglasses that can be worn with comfort over extended periods of time, even during rigorous physical activity.

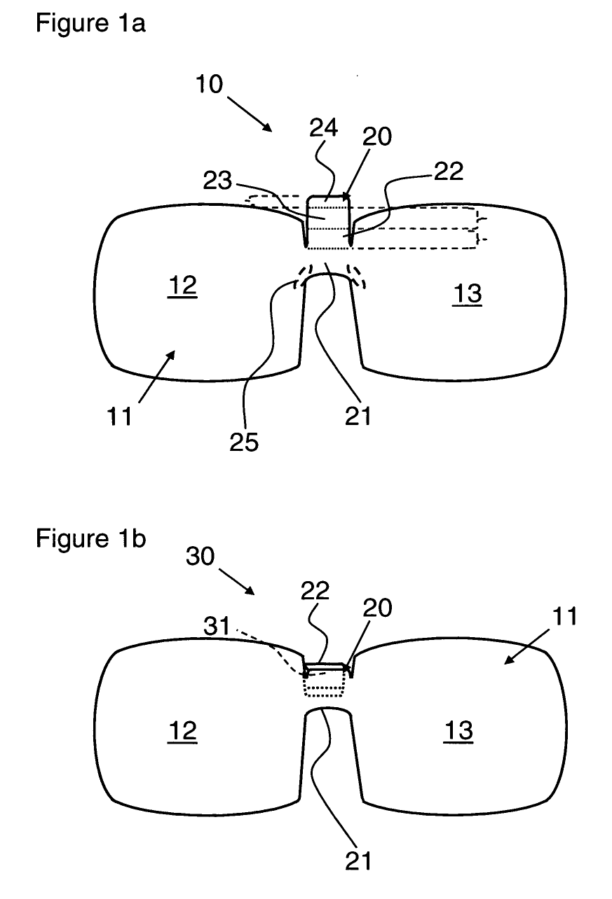

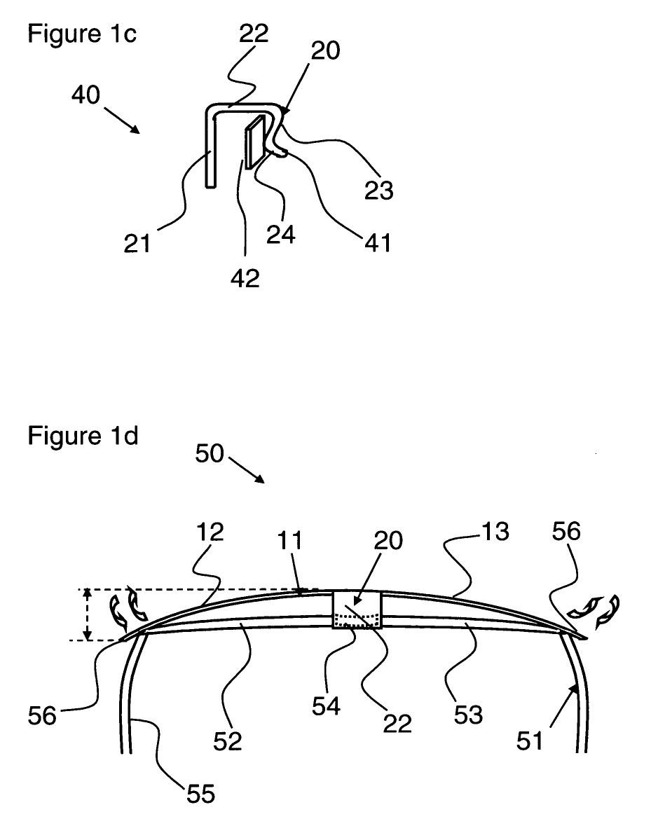

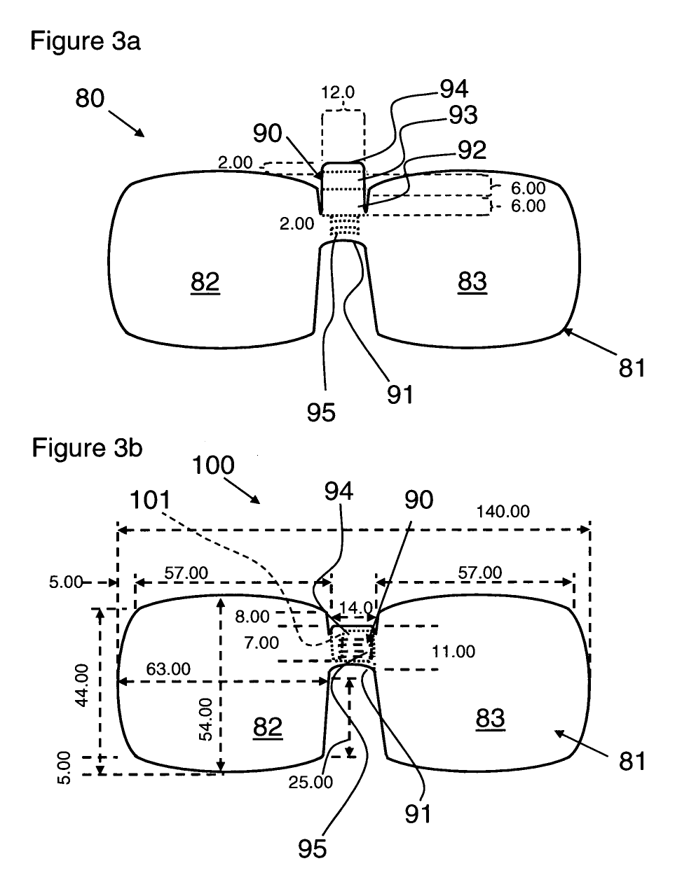

FIGS. 1a-1d illustrate an embodiment of the universal, cuttable clip-on auxiliary eyewear adapted to be cut to fit prescription eyeglasses. FIG. 1a shows a front view of the universal, cuttable clip-on auxiliary eyewear wherein the lens mounting member is disengaged, shown generally at 10. FIG. 1b shows a front view of the lens mounting member engaged in the clip position, shown generally at 30. Universal, cuttable clip-on auxiliary eyewear 10 includes a material sheet 11 which is adapted to be sized and cut to form fitting auxiliary eyewear for covering prescription eyeglasses. Optimal fitting of the auxiliary eyewear 10 is achieved on typical prescription or correction eyeglasses generally having a first eyeglass lens with a first lens perimeter, second eyeglass lens with a second lens perimeter, an eyeglass bridge, and left and right appendages. Material sheet 11 is constructed having a first lens portion 12, a lens mounting member 20 and a second lens portion 13. First and second lens portions, 12 and 13, respectively, are appointed for being traced upon to form a traced outline of the first and second eyeglass lens perimeters. (See FIGS. 3a and 3b herein). After forming a traced outline, first and second lens portions, 12 and 13, of material sheet 11 are appointed for cutting by a cutting device so that first and second lens portions 12 and 13 are sized for covering the first and second eyeglass lenses of the prescription eyeglasses.

Lens mounting member 20 of material sheet 11 is appointed for connecting first and second lens portions 12 and 13. In this embodiment, lens mounting member 20 and first and second lens portions 12 and 13 are attached together to form a unilateral material sheet 11. When cutting, the user must be careful to avoid cutting lens mounting member 20. Lens mounting member 20 is further appointed for removably mounting auxiliary eyewear 10 to the eyeglass bridge of the prescription eyeglasses. In this embodiment, lens mounting member 20 comprises a bridge guide 21, top guide 22, and folding members 23 and 24. Bridge guide 21 is constructed to comfortably fit over the nose bridge of the eyeglasses and visa vie the nose bridge of a wearer. Folding members 23 and 24 (illustrated via phantom lines to represent fold-ability) are appointed to engage with bridge guide 21 and top guide 22 to form a connector bridge channel 31 adapted to receive the eyeglass bridge of the eyeglasses. (See channel 31 in FIG. 1b). Alternatively, lens mounting member 20 further comprises round weights 25 to reinforce lens mounting member 20.

FIG. 1c shows a side view of the lens mounting member 20, shown generally at 40. FIG. 1d shows a top view of the auxiliary eyewear removably mounted on prescription eyeglasses, shown generally at 50. Lens mounting member 20 comprises folding members 23 and 24 which are bendable portions that are manipulated to form a clip-on device 41. Lens mounting member 20 may further include a clip stabilizer 42 located internally of the clip-on device 31. Preferably, clip stabilizer 42 is composed of a small piece of soft rubber or foam that is attached to the inside of the clip-on device 41 of lens mounting member 20 in order to stabilize lens mounting member 20 and visa vie the auxiliary eyewear when being worn. This clip stabilizer 42 further facilitates to stabilizing the auxiliary eyewear when there is less room between the top of the nose and the lens mounting member 20 (i.e. such as when the wearer's nose bridge is small). Eyeglasses 51 have a first eyeglass lens 52 with a first lens perimeter, second eyeglass lens 53 with a second lens perimeter, an eyeglass bridge 54, and left and right appendages 55. Material sheet 11 is composed of a thin polymeric material provided with protection from harmful sun rays. Preferably, material sheet 11 has a slightly arced shape so that the auxiliary eyewear has a spring back construction causing tension as illustrated by way of arrows 56.

In use, the material sheet 11 arced construction forms a convex shape when attached to the prescription eyeglasses 51, and when material sheet 11 and visa vie auxiliary eyewear 10 is not mounted on the prescription eyeglasses 51 the arced construction forms a concave shape. This tension facilitates in further securing the auxiliary eyewear on the prescription eyeglasses 51. Alternatively, first and second lens portions 12 and 13 of material sheet 11 are each constructed having a slightly arced shape so that first and second lens portions 12 and 13 form tension at the first and second eyeglass lens 52 and 53 site o the prescription eyeglasses. Material sheet 11 has a thickness ranging from 0.5 mm to 1.5 mm. Preferably, material sheet 11 has a thickness of at least 1 mm. This thickness range of the material sheet 11 facilitates the ability of the user to cleanly and efficiently cut the first and second lens portions to fit the eyeglass lenses. Prior to being cut, the auxiliary eyewear has a length ranging between 120 to 160 mm, and preferably ranging between 125 and 140 mm. The auxiliary eyewear before being cut has a width ranging between 40 to 65 mm, and preferably ranging between 50 to 60 mm.

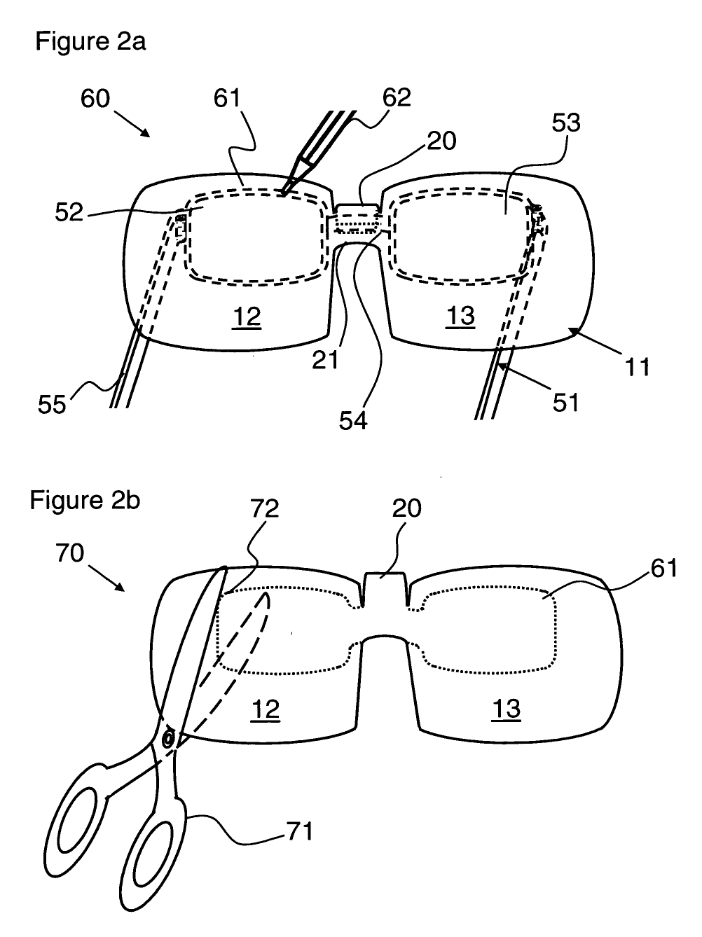

FIGS. 2a-2b illustrate the universal, cuttable clip-on auxiliary eyewear system and method utilized in preparing and assembling the auxiliary eyewear to fit prescription eyeglasses. FIG. 2a shows a tracing of the perimeter of the eyeglass lenses on the material sheet, shown generally at 60. FIG. 2b shows cutting of the traced outline for fitting the first and second lens portions to the eyeglass lenses, shown generally at 70. Universal, cuttable clip-on auxiliary eyewear includes a material sheet 11 constructed having first lens portion 12, lens mounting member 20 and second lens portion 13. Eyeglasses 51 having a first eyeglass lens 52 with a first lens perimeter, second eyeglass lens 53 with a second lens perimeter, an eyeglass bridge 54, and left and right appendages 55 are placed on material sheet 11 so that the first and second lens portions 12 and 13 are aligned with the first and second eyeglass lenses. Preferably, lens mounting member 20 is engaged so that material sheet 11 is mounted onto eyeglass bridge 54 before tracing of the perimeters of first and second eyeglass lenses 52 and 53 is carried out. A tracing instrument 62 is utilized, herein shown as a pen or pencil, to form a traced outline 61 of the perimeters of the first and second eyeglass lenses 52 and 53 on first and second lens portions 12 and 13 of material sheet 11. Material sheet 11 is then cut along traced outline 61 by way of cutting means 71, herein shown as scissors, to form the universal, cuttable clip-on auxiliary eyewear for eyeglasses 51. The sized and fitted auxiliary eyewear is then removably mounted onto eyeglass bridge 54 by way of lens mounting member 20.

FIGS. 3a-3b illustrate another embodiment of the universal, cuttable clip-on auxiliary eyewear, wherein: FIG. 3a shows a front view of the universal, cuttable clip-on auxiliary eyewear illustrating the lens mounting member in a disengaged state, shown generally at 80; and FIG. 3b illustrates a front view of the lens mounting member engaged in the clip position, shown generally at 100. universal, cuttable clip-on auxiliary eyewear 80 includes a material sheet 81 constructed having first lens portion 82, lens mounting member 90 and second lens portion 83. Universal, cuttable clip-on auxiliary eyewear 80 is adapted to be fitted to be removably mounted on a pair of eyeglasses having a first eyeglass lens with a first lens perimeter, second eyeglass lens with a second lens perimeter, an eyeglass bridge, and left and right appendages. Sized and fitted auxiliary eyewear is removably mounted onto the eyeglass bridge of the prescription eyeglasses by way of lens mounting member 90.

Continuing with FIGS. 3a and 3b, lens mounting member 90 of material sheet 81 is adapted for connecting first and second lens portions 82 and 83. In this embodiment, lens mounting member 90 and first and second lens portions 82 and 83 are attached together to form a unilateral material sheet 81. When cutting, the user must be careful to avoid cutting lens mounting member 90. In this embodiment, lens mounting member 90 comprises a bridge guide 91, top guide 92, and folding members 93 and 94. Bridge guide 91 is constructed to comfortably fit over the nose bridge of the eyeglasses and visa vie the nose bridge of a wearer. Folding members 93 and 94 (illustrated via phantom lines to represent fold-ability) are appointed to engage with bridge guide 91 and top guide 92 to form a connector bridge channel 101 adapted to receive the eyeglass bridge of the eyeglasses. (See channel 31 in FIG. 3b). As is best illustrated by way of FIG. 3b, in this embodiment, folding members 93 and 94 are bended and fold behind bridge guide 91 (and the eyeglass bridge when the auxiliary eyewear is being mounted on same) and folding member 94 enters under bridge guide 91. Bridge guide 91 of lens mounting member 90 further comprises at least one internal fastener 95 for receiving and securing folding member 94 thereunder when lens mounting member 90 is in the engaged or mounted position.

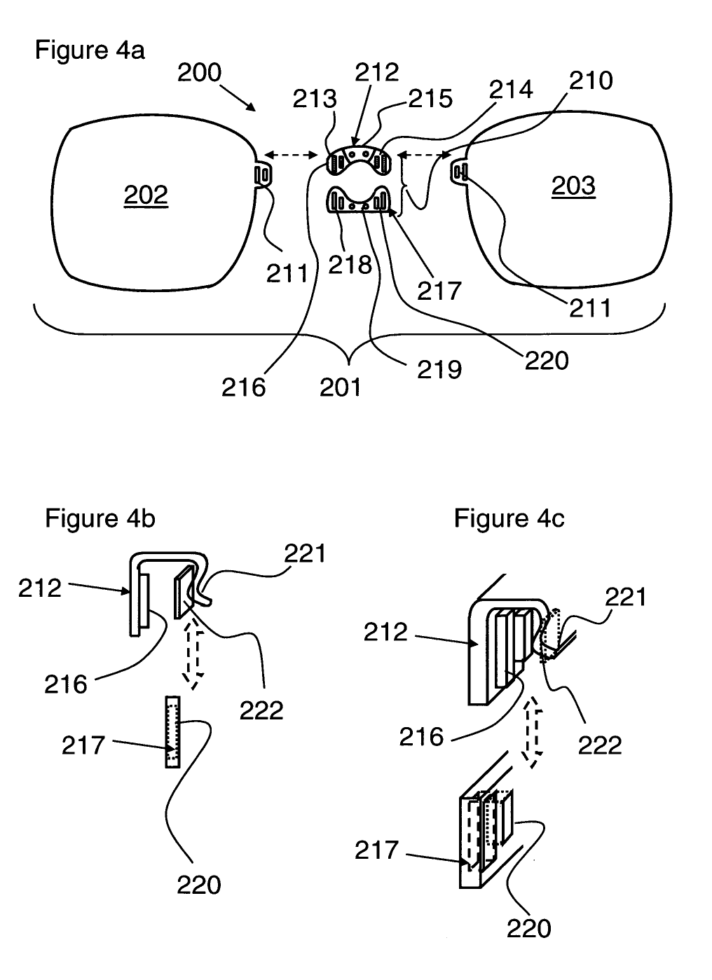

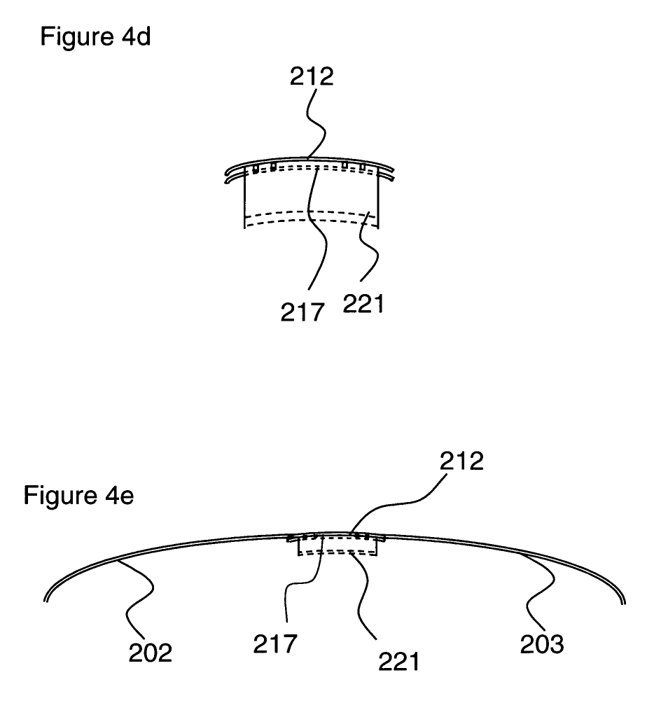

FIGS. 4a-4e illustrate another embodiment of the universal, cuttable clip-on auxiliary eyewear adapted to be cut to fit prescription eyeglasses wherein the first and second lens portions are provided with grooves and the lens mounting member is provided with tongues which are received within the grooves: FIG. 4a shows a front view of the universal, cuttable clip-on auxiliary eyewear wherein the lens mounting member is disengaged, shown generally at 200; FIG. 4b shows a side view of the lens mounting member utilized in this embodiment of the universal, cuttable clip-on auxiliary eyewear; FIG. 4c shows a side planer view of the lens mounting member of FIG. 4b; FIG. 4d shows a top view of the lens mounting member; and FIG. 4e shows a top view of the universal, cuttable clip-on auxiliary eyewear wherein the eyewear is adapted for removable mounting on prescription eyeglasses. Universal, cuttable clip-on auxiliary eyewear 200 includes a material sheet 201 constructed having first lens portion 202, lens mounting member 210 and second lens portion 203. Universal, cuttable clip-on auxiliary eyewear 200 is appointed to be fitted to be removably mounted on a pair of eyeglasses having a first eyeglass lens with a first lens perimeter, second eyeglass lens with a second lens perimeter, an eyeglass bridge, and left and right appendages. Sized and fitted auxiliary eyewear 200 is removably mounted onto the eyeglass bridge of the prescription eyeglasses by way of lens mounting member 210. In the embodiment show, first and second lens portions 202 and 203 of material sheet 201 are provided as separate lens portions, each further comprising at least one grooved rail portion 211. Lens mounting member 210 further comprises a front rail connector 212 having left and right sides, 213 and 214, respectively, and a central portion 215. Left and right sides 213 and 214 of front rail connector 212 each further comprise at least one tongued rail portion 216 appointed to be received within grooved rail portion 211 of each of first and second lens portions 202 and 203 for securing first and second lens portions 202 and 203 to lens mounting member 210. Lens mounting member 210 may further comprise a back rail connector 217 having back rail sides 218 and a back rail center 219. Back rail sides 218 of back rail connector 217 each have at least one tract rail portion 220 appointed for receiving tongued rail portion 216 of front rail connector 212 for further securing first and second lens portions 202 and 203 to lens mounting member 210. Lens mounting member 210 may further include a clip stabilizer 222 located internally of the clip-on device 221 (see FIGS. 4b and 4c). Preferably, clip stabilizer 222 is composed of a small piece of soft rubber or foam that is attached to the inside of the clip-on device 221 of lens mounting member 210 for stabilization thereof and visa vie the auxiliary eyewear when being worn. This clip stabilizer 222 further facilitates to stabilizing the auxiliary eyewear when there is less room between the top of the nose and the lens mounting member 210 (i.e. such as when the wearer's nose bridge is small).

In operation, eyeglass lenses are traced onto each of the respective first and second lens portions 202 and 203 to form a traced outline of the perimeter of the eyeglass lenses. A cutting device is utilized to cut along the traced outline on each of the first and second lens portions 202 and 203 so that each of the lens portions are sized to fit the eyeglass lenses. Grooved rail portions 211 of each of the first and second lens portions 202 and 203 are received in each of the tongued rail portions 216 on left and right sides 213 and 214 of front rail connector 212 of lens mounting member 210. As a result, first and second lens portions 202 and 203 are joined together by way of the engaged lens mounting member 210 via front rail connector 212. Optionally, back rail connector 217 having back rail sides 218 with at least one tract rail portion 220 is applied to further secure first and second lens portions 202 and 203 to front rail connector 212. Front rail connector 212 is further provided with a clip-on tool 221 for mounting on prescription eyeglasses.

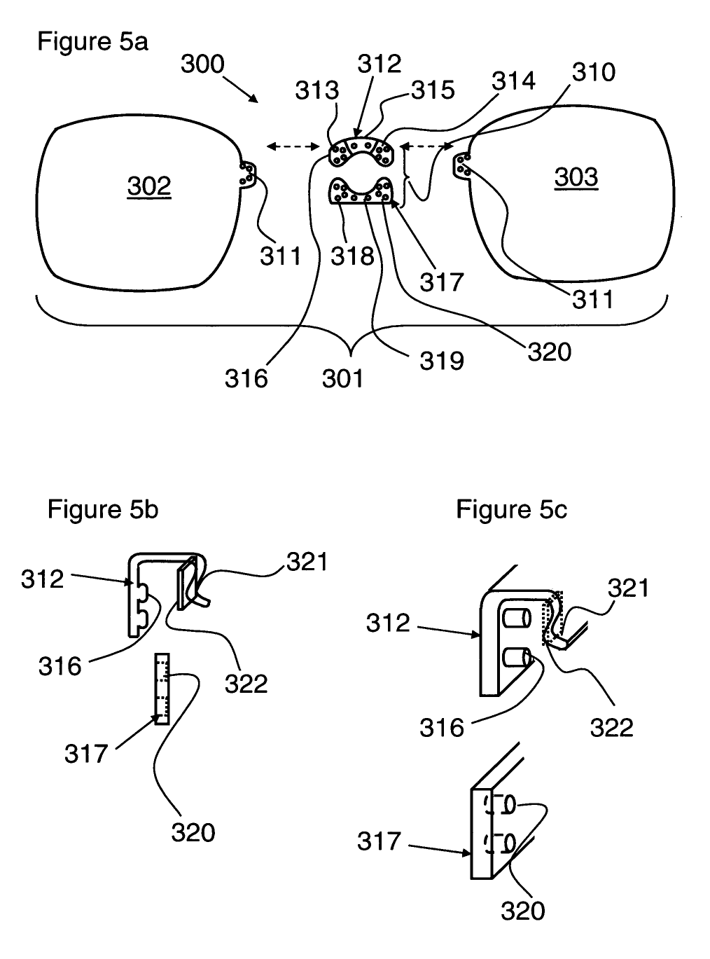

FIGS. 5a-5d illustrate another embodiment of the universal, cuttable clip-on auxiliary eyewear adapted to be cut to fit prescription eyeglasses wherein the first and second lens portions are provided with apertures and the lens mounting member is provided with buttons which are received within the grooves: FIG. 5a shows a front view of the universal, cuttable clip-on auxiliary eyewear wherein the lens mounting member is disengaged, shown generally at 300; FIG. 5b shows a side view of the lens mounting member utilized in this embodiment of the universal, cuttable clip-on auxiliary eyewear; FIG. 5c shows a side planer view of the lens mounting member of FIG. 5b. Universal, cuttable clip-on auxiliary eyewear 300 includes a material sheet 301 constructed having first lens portion 302, lens mounting member 310 and second lens portion 303. Universal, cuttable clip-on auxiliary eyewear 300 is adapted to be fitted to be removably mounted on a pair of eyeglasses having a first eyeglass lens with a first lens perimeter, second eyeglass lens with a second lens perimeter, an eyeglass bridge, and left and right appendages. Sized and fitted auxiliary eyewear 300 is removably mounted onto the eyeglass bridge of the prescription eyeglasses by way of lens mounting member 310. In the embodiment shown, first and second lens portions 302 and 303 of material sheet 301 are provided as separate lens portions, each further comprising at least one receiving hole 311. Lens mounting member 310 further comprises a front rail connector 312 having left and right sides, 313 and 314, respectively, and a central portion 315. Left and right sides 313 and 314 of front rail connector 312 each further comprise at least one button portion 316 appointed to be received within receiving hole 311 of each of first and second lens portions 302 and 303 for securing first and second lens portions 302 and 303 to lens mounting member 310. Lens mounting member 310 may further comprise a back rail connector 317 having back rail sides 318 and a back rail center 319. Back rail sides 318 of back rail connector 317 each have at least one receiving aperture 320 appointed for receiving button portion 316 of front rail connector 312 for further securing first and second lens portions 302 and 303 to lens mounting member 310. Lens mounting member 312 may further include a clip stabilizer 322 located internally of the clip-on device 321 (see FIGS. 5b and 5c). Preferably, clip stabilizer 322 is composed of a small piece of soft rubber or foam that is attached to the inside of the clip-on device 321 of lens mounting member 310 for stabilization thereof and visa vie the auxiliary eyewear when being worn. This clip stabilizer 322 further facilitates to stabilizing the auxiliary eyewear when there is less room between the top of the nose and the lens mounting member 310 (i.e. such as when the wearer's nose bridge is small).

In operation, eyeglass lenses are traced onto each of the respective first and second lens portions 302 and 303 to form a traced outline of the perimeter of the eyeglass lenses. A cutting device is utilized to cut along the traced outline on each of the first and second lens portions 302 and 303 so that each of the lens portions are sized to fit the eyeglass lenses. Receiving holes 311 of each of the first and second lens portions 302 and 303 are received in each of the button portions 316 on left and right sides 313 and 314 of front rail connector 312 of lens mounting member 310. As a result, first and second lens portions 302 and 303 are joined together by way of the engaged lens mounting member 310 via front rail connector 312. Optionally, back rail connector 317 having back rail sides 318 with at least one receiving aperture 320 is applied to further secure first and second lens portions 302 and 303 to front rail connector 312. Front rail connector 312 is further provided with a clip-on tool 321 for mounting on prescription eyeglasses.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. Universal, cuttable clip-on auxiliary eyewear, comprising:
a. a material sheet adapted to be sized and cut for removable attachment to eyeglasses, said eyeglasses having a first eyeglass lens with a first lens perimeter, a second eyeglass lens with a second lens perimeter, an eyeglass bridge, and left and right appendages;
b. said material sheet having a first lens portion, a lens mounting member and a second lens portion, said first and second lens portions being adapted to be traced upon to form a traced outline of said first and second eyeglass lenses and being further adapted to be cut by a cutting device so that said first and second lens portions are sized for covering said first and second eyeglass lenses; and
c. said lens mounting member of said material sheet being adapted to connect said first and second lens portions of said material sheet and for removably mounting said first and second lens portions of said material sheet to said eyeglass bridge of said eyeglasses.

2. Universal, cuttable clip-on auxiliary eyewear as recited by claim 1, wherein said lens mounting member comprises a bridge guide, top guide, and at least one folding member, said folding members being adapted to engage with said bridge guide and said top guide to form a connector bridge channel adapted to receive said eyeglass bridge of said eyeglasses.

3. Universal, cuttable clip-on auxiliary eyewear as recited by claim 2, wherein said folding members of said lens mounting member are constructed to fold-ably engage to form a clip-on device.

4. Universal, cuttable clip-on auxiliary eyewear as recited by claim 2, wherein said bridge guide of said lens mounting member further comprises at least one internal fastener.

5. Universal, cuttable clip-on auxiliary eyewear as recited by claim 4, wherein said at least one fastener is adapted to receive said folding member of said connector portion.

6. Universal, cuttable clip-on auxiliary eyewear as recited by claim 2, wherein said lens mounting member further comprises a clip stabilizer.

7. Universal, cuttable clip-on auxiliary eyewear as recited by claim 1, wherein said first and second lens portions of said material sheet each further comprise at least one grooved rail portion and said lens mounting member further comprises a front rail connector having left and right sides and a central portion, said left and right sides of said front rail connector each further comprises at least one tongued rail portion appointed to be received within said grooved rail portion of each of said first and second lens portions for securing said first and second lens portions to said lens mounting member.

8. Universal, cuttable clip-on auxiliary eyewear as recited by claim 7, wherein said lens mounting member further comprises a back rail connector having back rail sides and a back rail center, wherein said back rail sides of said back rail connector each having at least one tract rail portion adapted to receive said tongued rail portion of said front rail connector for further securing said first and second lens portions to said lens mounting member.

9. Universal, cuttable clip-on auxiliary eyewear as recited by claim 7, wherein said lens mounting member further comprises a clip stabilizer.

10. Universal, cuttable clip-on auxiliary eyewear as recited by claim 1, wherein said lens mounting member comprises round weights to reinforce said connector portion.

11. Universal, cuttable clip-on auxiliary eyewear as recited by claim 1, wherein said material sheet is composed of a thin polymeric material provided with protection from harmful sun rays.

12. Universal, cuttable clip-on auxiliary eyewear as recited by claim 1, wherein said material sheet has a slightly arced shape.

13. Universal, cuttable clip-on auxiliary eyewear as recited by claim 1, wherein said first and second lens portions of said material sheet each have a slightly arced shape.

14. Universal, cuttable clip-on auxiliary eyewear as recited by claim 1, wherein said material sheet has a thickness ranging from 0.5 mm to 1.5 mm.

15. Universal, cuttable clip-on auxiliary eyewear as recited by claim 14, wherein said material sheet has a thickness of at least 1 mm.

16. Universal, cuttable clip-on auxiliary eyewear as recited by claim 1, wherein said material sheet has a length ranging between 120 to 160 mm.

17. Universal, cuttable clip-on auxiliary eyewear as recited by claim 1, wherein said material sheet has a width ranging between 40 to 65 mm.

18. Universal, cuttable clip-on auxiliary eyewear as recited by claim 1, wherein said first and second lens portions each have a length ranging from 50 to 65 mm.

19. Universal, cuttable clip-on auxiliary eyewear as recited by claim 1, wherein said first and second lens portions each have a width ranging from 50 to 65 mm.

20. A universal, cuttable clip-on auxiliary eyewear system, comprising:
a. a material sheet adapted to be sized and cut for removable attachment to a pair of eyeglasses, said eyeglasses having a first eyeglass lens with a first lens perimeter, a second eyeglass lens with a second lens perimeter, an eyeglass bridge, and left and right appendages;
b. said material sheet having a first lens portion, a lens mounting member and a second lens portion;
c. said lens mounting member of said material sheet being adapted to connect said first and second lens portions of said material sheet and to removably mount said first and second lens portions of said material sheet to said eyeglass bridge of said eyeglasses;
d. a tracing instrument for forming a traced outline of said perimeters of said first and second eyeglass lenses on said first and second lens portions of said material sheet; and
e. cutting means for cutting said sheet of material along said traced outline to form a first and second covering for said first and second eyeglass lenses.

21. A method of making universal, cuttable clip-on auxiliary eyewear, comprising the steps of:
a. placing a pair of eyeglasses having a first eyeglass lens with a first lens perimeter, second eyeglass lens with a second lens perimeter, an eyeglass bridge, and left and right appendages on a material sheet adapted to be sized and cut, said material sheet having a first lens portion, a lens mounting member and a second lens portion;
b. aligning said first and second eyeglass lenses with said first and second lens portions of said material sheet;
c. tracing said perimeter of said first and second eyeglass lenses with a tracing instrument to form a traced outline of said first and second eyeglass lenses on said first and second lens portions of said material sheet;
d. cutting said sheet of material along said traced outline by way of cutting means to form said universal, cuttable clip-on auxiliary eyewear for said eyeglasses; and
e. mounting said universal, cuttable clip-on auxiliary eyewear to said eyeglass bridge by way of said lens mounting member of said material sheet so that said universal, cuttable clip-on auxiliary eyewear is removably mounted on said eyeglasses.
